(19) United States
(12) Patent Application Publication
(10) Pub. No.: US 2026/0203450 A1
(43) Pub. Date: Jul. 16, 2026

(54) Credential Stacking Engine for Hierarchical Influence Validation

(71) Applicant: George William Bickerstaff, III, Greenwich, CT (US)

(72) Inventor: George William Bickerstaff, III, Greenwich, CT (US)

(21) Appl. No.: 19/309,369

(22) Filed: Aug. 25, 2025

(51) Int. Cl. G06F 21/64; G06F 21/16

(52) U.S. Cl. CPC G06F 21/64; G06F 21/16

(57) ABSTRACT

The Credential Stacking Engine validates hierarchical influence by aggregating multi-source credentials, stacking them hierarchically to compute cumulative trust scores, verifying authenticity using cryptographic methods, auditing outcomes for compliance, and outputting validated results via a secure interface. It includes a credential input module for ingestion, a stacking processor for layered scoring, a verification engine for trust validation, an audit logger for compliance records, and an output interface for secure delivery. The method ingests credentials, stacks hierarchically, verifies influence, audits results, and delivers outputs for applications like reputation management and blockchain governance. This invention addresses fragmented credential validation by enabling structured, portable trust across distributed networks, ensuring GDPR compliance and interoperability.

### CROSS-REFERENCE TO RELATED APPLICATIONS

This application claims the benefit of U.S. Provisional Patent Application No. 63/847,353, filed on Jul. 20, 2025, the entire contents of which are incorporated herein by reference.

### CPC Classifications

G06Q 50/01 (organizational management; social networking)
G06F 16/9535 (structured data optimization)
H04L 9/32 (cryptographic mechanisms)
G06N 20/00 (machine learning applications)
H04L 9/00 (secure data validation systems)

### Definitions

For clarity and accurate interpretation, the following terms are defined as used in this specification (sorted alphabetically):
Audit Logger: A system component that records all credential stacking operations, verification outcomes, and compliance details for traceability and regulatory audits.
Credential Stacking: The process of aggregating and layering multiple credentials from diverse sources in a hierarchical structure to compute a cumulative trust profile.
GDPR: General Data Protection Regulation, an EU framework governing the secure processing, storage, and transfer of personal data in credential systems.
Hierarchical Influence: Structured authority and trust derived from layering credentials, where higher layers enhance validation based on lower-layer reliability.
Verification Engine: A component that authenticates stacked credentials using cryptographic methods and predefined trust metrics to ensure accuracy and integrity.

### FIELD OF THE INVENTION

This invention relates to data processing systems for validating credentials through hierarchical stacking to compute cumulative influence and trust, with applications in reputation management, blockchain governance, and distributed network systems.

### BACKGROUND OF THE INVENTION

Credential validation in digital ecosystems often processes credentials individually, failing to account for hierarchical relationships where multiple layers contribute to overall influence and trust. This leads to fragmented trust recognition, inefficiencies in cross-platform verification, and increased fraud risks. As decentralized and blockchain-based systems proliferate, a stacking engine is needed to aggregate, layer, and verify credentials cumulatively. Prior art offers solutions for credential aggregation and identity management but lacks structured hierarchical stacking with robust auditing. The following table summarizes key prior art and their limitations, verified through patent database searches (USPTO, Google Patents, August 2025):

| | Document | | | |
|---|---|---|---|---|
| Reference | Number | Description | Limitation | Verification |
| US20180345678A1 | US20180345678A1 | Road surface | Aggregates data | Verified via |
| (2018) | | profiler | but lacks | USPTO Patent |
| | | performance | hierarchical | Public Search; |
| | | measuring | stacking logic | focuses on road |
| | | instrument | for cumulative | profiling, not |
| | | | credential | credential |
| | | | scoring | aggregation |
| US20200026834A1 | US20200026834A1 | Blockchain | Manages | Verified via |
| (2020) | | identity safe and | identity; no | Google Patents; |
| | | authentication | hierarchical | emphasizes |
| | | system | layering or | identity storage |
| | | | cumulative | and safe |
| | | | influence | |
| | | | validation | |
| U.S. Pat. No. | U.S. Pat. No. | Trust scoring for | Provides trust | Verified via |
| 10,356,105B2 | 10,356,105B2 | network security | scores for | USPTO; limited |
| (2019) | | | security; lacks | to security |
| | | | audit logging | scoring |
| | | | and hierarchical | |
| | | | validation | |
| U.S. Pat. No. | U.S. Pat. No. | Blockchain | Batches | Verified via |
| 11,886,557B2 | 11,886,557B2 | credentials | credentials on | Google Patents; |
| (2024) | | management | single | focuses on single- |
| | | system | blockchain; no | chain management |
| | | | multi-source | |
| | | | stacking engine | |
| U.S. Pat. No. | U.S. Pat. No. | Establishing | Builds | Verified via |
| 10,360,191B2 | 10,360,191B2 | overlay trust | consensus for | USPTO; |
| (2019) | | consensus for | trust; lacks | addresses |
| | | blockchain | structured | consensus |
| | | | stacking and | mechanisms |
| | | | secure output | |
| | | | interface | |

These prior arts advance blockchain and trust scoring but fail to provide a comprehensive system for hierarchical credential stacking, verification, auditing, and secure output, which this invention addresses through a structured engine with layered processing and compliance features.

### SUMMARY OF THE INVENTION

The Credential Stacking Engine provides a system and method for hierarchical influence validation by aggregating multi-source credentials, stacking them to compute cumulative trust scores, verifying authenticity with cryptographic checks, auditing outcomes, and delivering secure outputs. The system includes an input module with aggregation and filtering, a stacking processor for hierarchical layering and scoring, a verification engine for fraud detection, an audit logger for compliance and traceability, and an output interface for secure delivery and integration. The method ingests credentials, stacks hierarchically, verifies influence, audits results, and outputs validations for reputation and governance applications. Advantages include enhanced trust portability, fraud prevention, GDPR compliance, and interoperability across distributed networks.

### BRIEF DESCRIPTION OF THE DRAWINGS

The drawings illustrate embodiments of the invention and are submitted as separate sheets in compliance with 37 CFR § 1.81.

FIG. 1: System Architecture Overview, depicting the overall structure and data flow of the Credential Stacking Engine.

FIG. 2: Stacking Processing Pipeline, illustrating the hierarchical layering and scoring of credentials.

FIG. 3: Verification Framework, showing the cryptographic and trust validation process.

FIG. 4: Audit Logging Workflow, detailing the compliance and traceability recording mechanisms.

FIG. 5: Flowchart of Output Processes, outlining secure delivery and integration of validation results.

### LIST OF FIGURES WITH REFERENCE NUMBERS

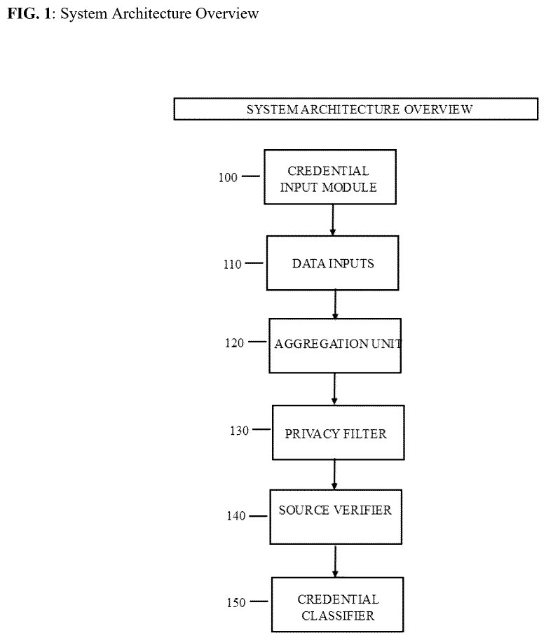

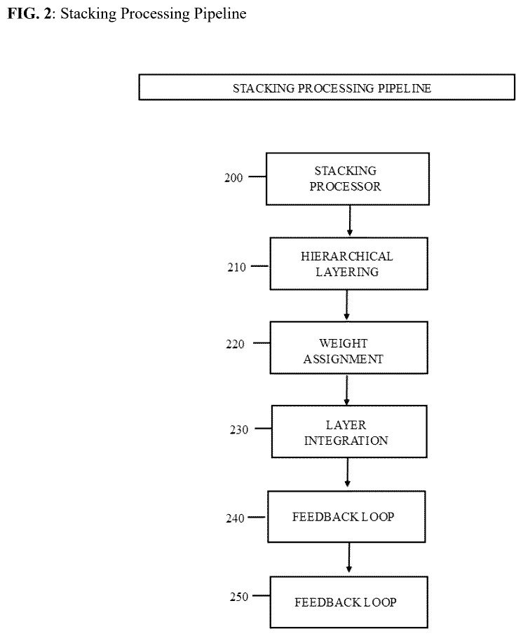

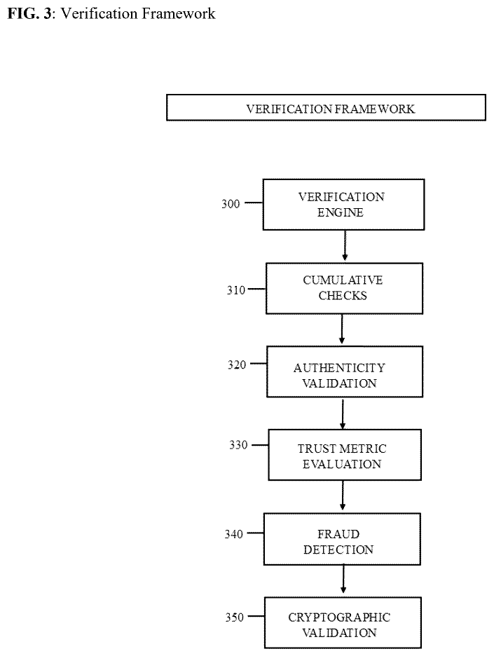

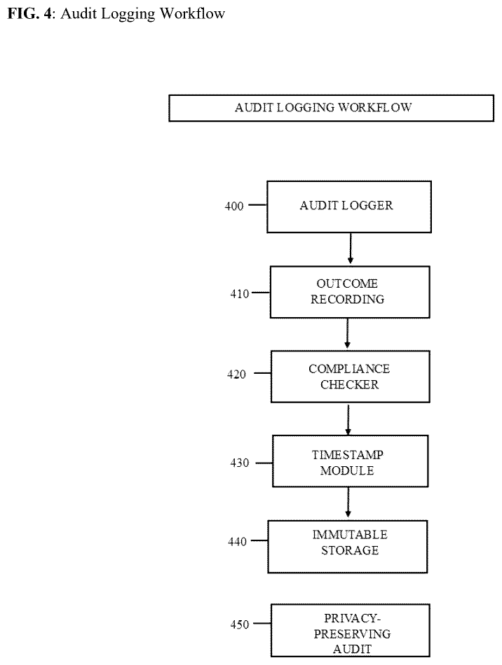

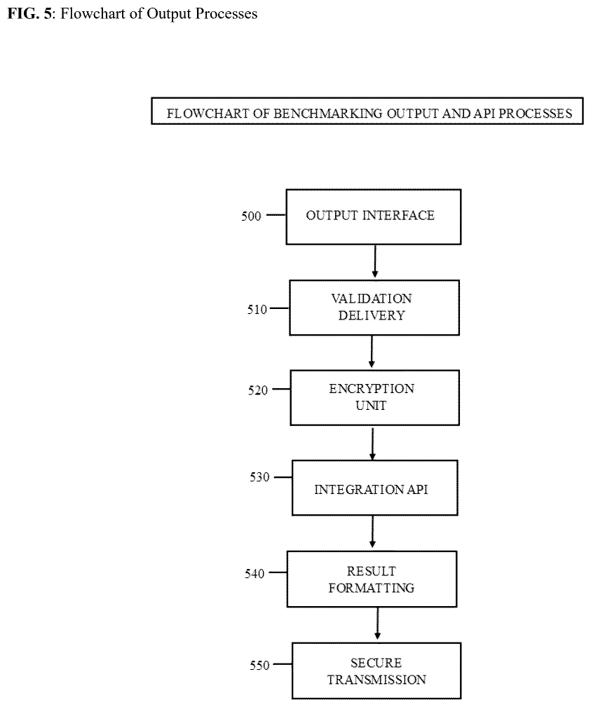

FIG. 1: System Architecture Overview
100: Credential Input Module
110: Data Inputs
120: Aggregation Unit
130: Privacy Filter
140: Source Verifier
150: Credential Classifier
FIG. 2: Stacking Processing Pipeline
200: Stacking Processor
210: Hierarchical Layering
220: Weight Assignment
230: Cumulative Scoring
240: Layer Integration
250: Feedback Loop
FIG. 3: Verification Framework
300: Verification Engine
310: Cumulative Checks
320: Authenticity Validation
330: Trust Metric Evaluation
340: Fraud Detection
350: Cryptographic Validation
FIG. 4: Audit Logging Workflow
400: Audit Logger
410: Outcome Recording
420: Compliance Checker
430: Timestamp Module
440: Immutable Storage
450: Privacy-Preserving Audit
FIG. 5: Flowchart of Output Processes
500: Output Interface
510: Validation Delivery
520: Encryption Unit
530: Integration API
540: Result Formatting
550: Secure Transmission

### DETAILED DESCRIPTION OF THE INVENTION

This section explains how to make and use the invention, with references to the drawings. Modifications are possible within the scope, provided they do not depart from the inventive concept.

### System Overview

In one embodiment, as shown in FIG. 1 with reference 100, the Credential Stacking Engine (CSE) operates in a distributed computing environment, such as cloud or blockchain networks, to validate hierarchical influence securely. It processes credentials from social platforms, blockchain ledgers, or analytics databases while ensuring GDPR compliance through encryption, anonymization, and minimal data retention, supporting applications like reputation management and decentralized governance.

### Core Components

### Credential Input Module

In one embodiment, illustrated in FIG. 1 with reference 100, this module ingests credentials from diverse sources (reference 110), such as blockchain records, social media endorsements, or verified certifications. The aggregation unit (reference 120) consolidates multi-format inputs, the privacy filter (reference 130) ensures GDPR compliance via anonymization, the source verifier (reference 140) checks authenticity using cryptographic signatures or metadata validation, and the credential classifier (reference 150) categorizes credentials for efficient processing.

### Stacking Processor

In one embodiment, as shown in FIG. 2 with reference 200, this processor performs hierarchical layering (reference 210) to organize credentials by trust levels (e.g., primary, secondary). It assigns weights based on source reliability and context (reference 220), computes cumulative scores (reference 230) using algorithmic aggregation, integrates layers into a unified trust profile (reference 240), and implements a feedback loop (reference 250) to adapt weights dynamically based on new data.

### Verification Engine

In one embodiment, depicted in FIG. 3 with reference 300, this engine conducts cumulative checks (reference 310) across stacked layers to ensure consistency. It validates authenticity using cryptographic methods like digital signatures (reference 320), evaluates against predefined trust metrics such as reputation scores (reference 330), detects fraud through anomaly detection algorithms (reference 340), and applies cryptographic validation (reference 350) to ensure data integrity.

### Audit Logger

In one embodiment, shown in FIG. 4 with reference 400, this logger records outcomes (reference 410) for transparency and accountability. The compliance checker (reference 420) ensures adherence to regulations like GDPR, the timestamp module (reference 430) logs events chronologically, immutable storage (reference 440) uses blockchain or secure databases for tamper-proof records, and the privacy-preserving audit (reference 450) protects sensitive data while enabling authorized access.

### Output Interface

In one embodiment, as shown in FIG. 5 with reference 500, this interface delivers validated outcomes (reference 510) securely to users or systems. The encryption unit (reference 520) protects data using cryptographic protocols, the integration API (reference 530) supports third-party system compatibility, result formatting (reference 540) ensures outputs in formats like JSON or XML, and secure transmission (reference 550) uses encrypted channels for reliable delivery.

### Operational Method

The CSE operates by:

Ingesting credentials through the input module (FIG. 1 with reference 100), aggregating via the unit (reference 120), filtering for privacy (reference 130), verifying sources (reference 140), and classifying credentials (reference 150).

Stacking credentials hierarchically in the processor (FIG. 2 with reference 200), layering (reference 210), assigning weights (reference 220), scoring cumulatively (reference 230), integrating layers (reference 240), and adapting via feedback (reference 250).

Verifying influence in the engine (FIG. 3 with reference 300), performing checks (reference 310), validating authenticity (reference 320), evaluating metrics (reference 330), detecting fraud (reference 340), and applying cryptographic validation (reference 350).

Auditing outcomes via the logger (FIG. 4 with reference 400), recording results (reference 410), checking compliance (reference 420), timestamping (reference 430), storing immutably (reference 440), and ensuring privacy-preserving audits (reference 450).

Outputting validations through the interface (FIG. 5 with reference 500), delivering securely (reference 510), encrypting (reference 520), integrating via API (reference 530), formatting results (reference 540), and transmitting securely (reference 550).

### ADVANTAGES

The CSE provides structured validation, enhances trust portability across platforms, reduces fraud through layered verification, ensures GDPR compliance, and supports interoperability, making it ideal for decentralized reputation systems and blockchain governance.

What is claimed is:

1. A computerized system for hierarchical influence validation as shown in FIG. 1 with reference 100, comprising: one or more processors; and memory storing instructions that, when executed, cause the system to: ingest credentials via a credential input module as shown in FIG. 1 with reference 100; stack hierarchically via a stacking processor as shown in FIG. 2 with reference 200; verify cumulative influence via a verification engine as shown in FIG. 3 with reference 300; log results via an audit logger as shown in FIG. 4 with reference 400; and output validation via an output interface as shown in FIG. 5 with reference 500.

2. A computer-implemented method for hierarchical influence validation as shown in FIG. 1 with reference 100, comprising: ingesting credentials; stacking hierarchically as shown in FIG. 2 with reference 200; verifying cumulative influence as shown in FIG. 3 with reference 300; auditing results as shown in FIG. 4 with reference 400; and outputting validation as shown in FIG. 5 with reference 500.

3. A non-transitory computer-readable storage medium storing instructions that, when executed by a processor, cause performance of a method for hierarchical influence validation as shown in FIG. 1 with reference 100, comprising: ingesting credentials; stacking hierarchically as shown in FIG. 2 with reference 200; verifying cumulative influence as shown in FIG. 3 with reference 300; auditing results as shown in FIG. 4 with reference 400; and outputting validation as shown in FIG. 5 with reference 500.

4. The system of claim 1, wherein credentials include cross-platform trust records from blockchain and social platforms.

5. The system of claim 1, wherein stacking combines verified credentials hierarchically as shown in FIG. 2 with reference 200.

6. The system of claim 1, wherein verification uses cumulative scoring and cryptographic checks as shown in FIG. 3 with reference 350.

7. The system of claim 1, wherein audits generate immutable, privacy-preserving logs as shown in FIG. 4 with reference 450.

8. The system of claim 1, wherein outputs support governance and reputation applications as shown in FIG. 5 with reference 550.

9. The system of claim 1, wherein instructions dynamically adapt stacking weights based on source reliability and context.

10. The method of claim 2, wherein ingesting includes GDPR-compliant data handling with privacy filters as shown in FIG. 1 with reference 130.

11. The method of claim 2, wherein stacking applies hierarchical algorithms for layer integration as shown in FIG. 2 with reference 240.

12. The method of claim 2, wherein verifying ensures alignment with trust metrics and fraud detection as shown in FIG. 3 with reference 340.

13. The method of claim 2, wherein auditing incorporates timestamped, immutable records as shown in FIG. 4 with reference 440.

14. The method of claim 2, wherein outputting delivers encrypted certifications via API as shown in FIG. 5 with reference 530.
